(19) United States
(12) Patent Application Publication
(10) Pub. No.: US 2026/0349181 A1
(43) Pub. Date: Nov. 5, 2026

(54) ASYMMETRIC MULTI-RING RESONATOR

(71) Applicant: Taiwan Semiconductor Manufacturing Company, Ltd., Hsinchu (TW)

(72) Inventors: Shao-Da Wang, New Taipei City (TW); Chih-Tsung Shih, Hsinchu City (TW); Sheng Kai Yeh, Taichung City (TW); Chi-Yuan Shih, Hsinchu (TW)

(21) Appl. No.: 19/742,087

(22) Filed: Jul. 15, 2026

Related U.S. Application Data
(63) Continuation of application No. 18/889,748, filed on Sep. 19, 2024.
(60) Provisional application No. 63/643,563, filed on May 7, 2024.

(51) Int. Cl. G02B 6/293; G02B 6/136

(52) U.S. Cl. CPC G02B 6/29343; G02B 6/136

(57) ABSTRACT

A photonic integrated circuit has an asymmetric dual ring resonator. The asymmetric dual ring resonator includes a first ring having a first effective length and a second ring having a second effective length, which is distinct from the first effective length. The first effective length and the second effective length are near integer multiples of a third effective length. The third effective length is within about an order or magnitude of the first effective length and the second effective length. The asymmetric dual ring resonator has a free spectral range corresponding to a single ring resonator having the third effective length but has a lower sensitivity to manufacturing process variations than would a single ring resonator having the third effective length.

### REFERENCE TO RELATED APPLICATIONS

This application is a Continuation of U.S. application Ser. No. 18/889,748, filed on Sep. 19, 2024, which claims the benefit of U.S. Provisional Application No. 63/643,563 filed on May 7, 2024. The contents of the above-referenced Patent Applications are hereby incorporated by reference in their entirety.

### BACKGROUND

Photonic integrated circuit (PIC) devices are widely used in communications and are increasingly being used for sensing and computing. PIC devices may operate at higher speeds than electrical integrated circuit (IC) devices. A PIC includes two or more optical devices coupled to form a circuit. Examples of optical devices include waveguides, splitters, multiplexers, filters, modulators, sensors, and switches. PIC devices may interface with ICs through lasers, photodiodes, and the like to provide additional functionality. As with ICs, there is an ongoing need to provide PIC devices with ever higher component densities.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a plan views of a PIC device with an asymmetric multi-ring resonator according to an embodiment of the present disclosure.

FIGS. 2A-2C illustrate cross-sectional views of the PIC device of FIG. 1 in accordance with various embodiments.

FIGS. 3-10 illustrate plan views of PIC devices with asymmetric multi-ring resonators according to various embodiments of the present disclosure.

FIGS. 11A-13B are paired plan and cross-sectional views of PIC devices with asymmetric multi-ring resonators according to various embodiments of the present disclosure.

FIGS. 14-16 illustrate plan views of PIC devices with asymmetric multi-ring resonators according to various embodiments of the present disclosure.

FIGS. 17-20 are a series of cross-sectional views illustrating some embodiments of a method of forming a PIC device with an asymmetric multi-ring resonator.

FIG. 21 provides a flow chart illustrating some embodiments of a method of forming a PIC device with an asymmetric multi-ring resonator.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Wavelength division multiplexing (WDM) is commonly used for communication through optical fibers. WDM increases bandwidth by allowing a single optical fiber to simultaneously carry multiple signals. PIC devices that receive or transmit multiplexed signals make extensive use of ring resonators. Ring resonators have the property of selectively transmitting signals at wavelengths corresponding to their primary resonance modes and attenuating or blocking signals at other wavelengths. The primary resonance modes are wavelengths of light for which the optical path length for a loop around the ring (the effective length of the ring) is approximately an integer multiple of the wavelength. The primary wavelengths have a periodic spacing, which is known as the free spectral range (FSR). The FSR in the frequency domain is given by the formula:

$$F = \frac{c}{{L}_{eff}}$$

where c is the speed of light and L_{eff} is the effective length for a loop around the ring. The effective length is the length of the perimeter of the ring multiplied by the group index. The group index is a ratio between the speed of light in a vacuum and the speed of light in the ring. The group index is similar to the refractive index but takes into account dispersion and other effects which depend on the ring geometry.

The bandwidth of a WDM system is proportional to the number of usable channels that can fit into one FSR interval. There is a minimum acceptable channel spacing, so the number of usable channels is proportional to the FSR. FSR can be increased by using smaller rings which reduces L_{eff}, but as the rings are made smaller, their sensitivity to manufacturing process variations increases so that manufacturing process variation becomes a limiting factor.

One aspect of the present disclosure is a PIC having an asymmetric dual ring resonator comprising a first ring having a first effective length and a second ring having a second effective length. The first effective length and the second effective length are distinct from one another and are selected so that the dual ring resonator has a larger FSR than a ring resonator having either the first effective length or the second effective length. It has been found that if the first effective length and the second effective length are near integer multiples (greater than one) of a third effective length corresponding to the larger FSR, and the third effective length is within about an order or magnitude of the first effective length and the second effective length, the sensitivity to manufacturing process variations is sufficiently low so that the larger FSR may be realized.

The foregoing concept of an asymmetric dual ring resonator may be extended to a multi-ring resonator having three or more rings coupled in series. In some embodiments, the third ring has the same effective length as either the first ring or the second ring. This configuration combines advantages of a symmetric dual ring resonator, such as improved filtering, with the advantages of an asymmetric dual ring resonator. In some embodiments, the third ring has an effective length that is also a near integer multiple of the third effective length, but is distinct from both the first effective length and the second effective length. An even greater FSR may be realized by using three or more rings that have effective lengths each of which is a distinct near integer multiple of one smaller effective length.

In some embodiments, a first ring has a radial thickness distinct from a second ring in the heterogeneous multi-ring resonator. The radial thickness affects the group index. In an asymmetric multi-ring ring resonator, varying the radial thickness provides a way of fine tuning the effective length without have to varying the distance between the first ring and the second ring, the distances between the multi-ring resonator and input and output waveguides, and without repositioning the waveguides or the rings. The variation in width may be limited so that the multi-ring resonator supports only one optical mode. The first ring may be coupled to a first waveguide and the second ring may be coupled to a second waveguide. The first waveguide and the second waveguide are the input and output waveguides.

In some embodiments, a spacing between a first ring and a second ring in the asymmetric multi-ring ring resonator is greater than a spacing between the first ring and the first waveguide. It has been found that the asymmetric multi-ring resonator benefits from high coupling coefficients with input and output waveguides, but making the coupling coefficients between the rings too large degrades the Q-factor.

In some embodiments, a first ring in the asymmetric multi-ring ring resonator, or more than one ring, is non-circular. In some embodiments, the non-circular ring has a lower radius of curvature in an area where it is coupled with another PIC device such as a waveguide. The reduced curvature may be used to increase the coupling coefficient. Alternatively, the reduce curvature may be used to achieve a given coupling coefficient with a lower sensitivity to manufacturing process variations. In some embodiments, the waveguide is curved to match a curvature of the ring in its coupling region. In some embodiments, the non-circular ring provides a more compact layout than an equivalent PIC with a circular ring. A ring can be made non-circular to some degree without affecting the free spectral range.

In some embodiments, the input and output waveguides are in a first optical device layer having a first elevation over the substrate and the asymmetric multi-ring resonator is in a second optical device layer having a second elevation over the substrate. A spacing between the layers may then be used to precisely control spacing between the asymmetric multi-ring ring resonator and the input and output waveguides.

In some embodiments, the first ring is in a first optical device layer having a first elevation over the substrate and the second ring is in a second optical device layer having a second elevation over the substrate. The first device layer and the second device layer may use distinct optical materials so that the first ring and the second ring have distinct compositions. In some embodiments, one of the optical materials is a non-linear optical material so that the multi-ring resonator may provide non-linear optical effects.

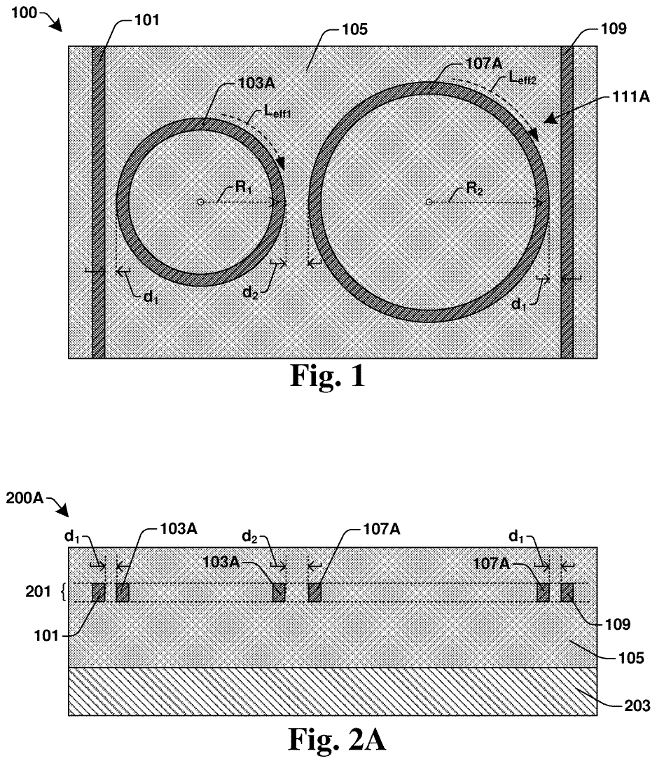

FIG. 1 illustrates a plan view of a PIC device 100 comprising an asymmetric dual ring resonator 111A. The asymmetric dual ring resonator 111A comprises a first ring 103A optically coupled with a second ring 107A. The first ring 103A is optically coupled to a first waveguide 101 and the second ring 107A is optically coupled to a second waveguide 109. The first waveguide 101 and the second waveguide 109 provide input and output waveguides for the asymmetric dual ring resonator 111A. The first waveguide 101, the first ring 103A, the second ring 107A, and the second waveguide 109 are composed of an optical material and are surrounded by cladding 105.

The first ring 103A has a first radius R₁ and a first effective length L_{eff1} and the second ring 107A has a second radius R₁ and a second effective length L_{eff2}. The first effective length L_{eff1} is distinct from the second effective length L_{eff2}. The first ring 103A and the second ring 107B are circular and have equal radial widths so that the difference in effective lengths is proportional to the difference in radii.

The first effective length L_{eff1} and the second effective length L_{eff2} are predetermined so that the FSR for the asymmetric dual ring resonator 111A is greater than the FSR for a single ring resonator having either the first effective length L_{eff1} or the second effective length L_{eff2}. The FSR for the asymmetric dual ring resonator 111A is a first integer multiple of the FSR for a single ring resonator having the first effective length L_{eff1} and is a second integer multiple of the FSR for a single ring resonator having the second effective length L_{eff2}, wherein the first and second integers are small integers greater than 1.

The FSR may be determined by plotting signal transmission efficiency as a function of wavelength. The plot will show transmission efficiency peaks. The highest peaks are the resonant modes. The wavelength separation between the resonant modes is a measure of FSR. FSR in the frequency domain (FSR_{f}) is related to (FSR_{Δ2}) in the wavelength domain by the formula:

$${FSR}_{f} = \frac{c}{{λ}^{2}} {FSR}_{Δλ}$$

$$thus$$

$${FSR}_{Δλ} = \frac{{λ}^{2}}{{L}_{eff}}$$

Between the highest peaks, which are the resonant modes, lower peaks may be observed. These lower peaks are side modes. For the heterogeneous multi-ring resonator to be effective, the transmission losses at the resonant modes must be acceptable, and there must be a sufficient contrast between the resonant modes and the side modes. As the ratios between the effective lengths of the rings and their least common divisor increases, the contrast between the resonant modes and the side modes decreases.

In a first embodiment, R₁ is two times R₀ and R₂ is three times R₀, where R₀ is the radius of a single ring resonator that would have the same FSR as the asymmetric dual ring resonator 111A. An example of this embodiments would be the case where R₁ is 6 μm, R₂ is 9 μm, and the first ring 103A and the second ring 107A have the same group index. The FSR for the asymmetric dual ring resonator 111A would then be the same as for a single ring resonator having a 3 μm radius, which is twice the FSR for a single ring resonator having a 6 μm radius. For this example, signals with wavelengths corresponding to the resonant modes may have an intensity drop in the range from about −1 db to about −3 db. By contrast, signals with wavelengths corresponding to the side modes may exhibit intensity drops of −18 db or greater. The transmission efficiencies for signals on or about the side mode wavelengths are more than an order of magnitude lower than the transmission efficiencies for signals at or about the resonant mode wavelengths. These differences are large enough to provide effective filtering for all but the resonant mode signals.

In a second embodiment, R₁ is three times R₀ and R₂ is four times R₀. The side mode intensities will be slightly greater than for the first embodiments, but easily remain more than an order of magnitude lower than the transmission efficiencies for signals at or about the resonant mode wavelengths. If R₁ is the same in both the first and second embodiments, the second embodiment provides a 50% greater FSR than the first embodiment.

In a third embodiment, R₁ is six times R₀ and R₂ is seven times R₀. The signals with wavelengths corresponding to the resonant modes may be similar to the previous embodiments and have an intensity drop in the range from about −1 db to about −3 db. The side mode intensities will show a significant increase in comparison to the first and second embodiments, but may remain at about −14 db or less and still be more than an order of magnitude lower than the transmission efficiencies for signals at or about the resonant mode wavelengths. If R₁ is the same in both the first and third embodiments, the third embodiment provides a 200% greater FSR than the first embodiment.

In a fourth embodiment, R₁ is twelve times R₀ and R₂ is thirteen times R₀. An example of this embodiments would be the case where R₁ is 6 μm, R₂ is 6.5 μm assuming the first ring 103A and the second ring 107A have the same group index. For this embodiment, the transmission losses for the side mode intensities may be only about −9 db, which are within an order of magnitude of the transmission losses for signals at the resonant mode wavelengths. This difference in transmission efficiency between what are intended to be the resonant modes and what are intended to be the side modes may be too small for some applications. If the intended resonant modes are sufficiently distinct from the side modes, this embodiment provides a 500% FSR increase over the first embodiment and an 1100% increase over the FSR of a single ring resonator having R₁. However, if the intended resonant modes are not sufficiently distinct from the side modes there is no increase in FSR compared to a single ring resonator having R₁.

These examples are operative if the resonance mode peaks are sufficiently well defined and sufficiently distinct from the side modes. In order for the resonance mode peaks to be sufficiently well defined, L_{eff1} and L_{eff2} must both be near to small integer multiples of an L_{eff3}. “near” in this context generally means within about 1/10 of 1 percent. L_{eff3} may be defined to be a first integer fraction of L_{eff1}. L_{eff2} should than be a near integer multiple of L_{eff3}. As L_{eff2} reaches a deviation of about 1/10 of 1 percent from an exact integer multiple of L_{eff3}, the efficiency of transmission at the resonant mode wavelength begins to show a noticeable decrease and the resonant mode peaks begin to split into double peaks. Accordingly, an asymmetric dual ring resonator is made to realize an increased FSR in comparison to the individual rings by keeping L_{eff2} within about 1/10 of 1 percent of m*L_{eff3}, where L_{eff3} is L_{eff1}/n, and m and n are small integers, each greater than 1, and without a common divisor greater than 1. In some embodiments, m and n are 12 or less. In some embodiments, m and n are 10 or less. In some embodiments, m and n are 7 or less. In some embodiments, m and n are 4 or less. The smaller m and n, and the closer L_{eff2} is to an integer multiple of L_{eff3}, the better the performance of the asymmetric dual ring resonator 111A.

Returning to FIG. 1, the first ring 103A is separated from the first waveguide 101 by a distance d₁. In some embodiments, d₁ is in the range from about 50 nm to about 300 nm. In some embodiments, the coupling coefficient (kappa squared) between the first ring 103A and the first waveguide 101 is in the range from about 0.25% to about 30%. In some embodiments, the coupling coefficient between the first ring 103A and the first waveguide 101 is at least about 2%. These comments also apply to the relationship between the second ring 107A and the second waveguide 109.

The first ring 103A is separated from the second ring 107A by a distance d₂. The distance d₂ is greater than the d₁. In some embodiments, d₂ is in the range from about 100 nm to about 350 nm. In some embodiments, d₂ is at least about double d₁. In some embodiments, the coupling coefficient between the first ring 103A and the second ring 107A is in the range from about 0.05% to about 2.5%. In some embodiments, the coupling coefficient between the first ring 103A and the second ring 107A is in the range from about 0.05% to about 1%. If the coupling coefficient is too low, transmission efficiency may be inadequate. If the coupling coefficient is too high, Q-factor is diminished, resonance peaks may split, and other undesirable effects may occur. In some embodiments, the coupling coefficient between the first ring 103A and the second ring 107A is about half or less than half the coupling coefficient between the first ring 103A and the first waveguide 101. In some embodiments, the coupling coefficient between the first ring 103A and the second ring 107A is about 10% or less than 10% the coupling coefficient between the first ring 103A and the first waveguide 101.

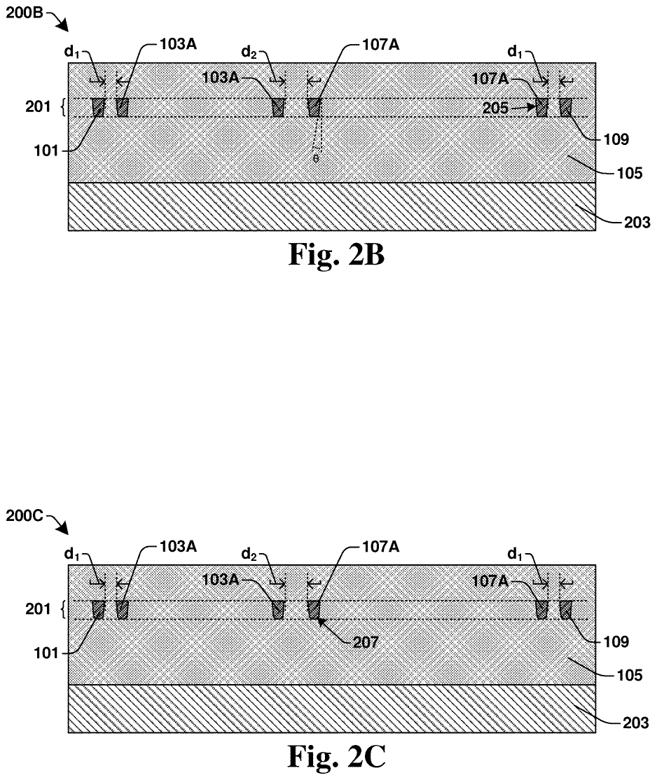

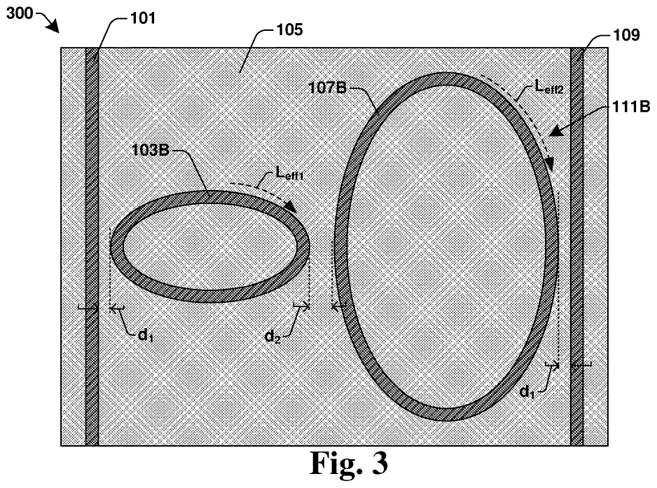

FIG. 2A illustrates a cross-sectional view 200A corresponding to an embodiment of the PIC device 100 of FIG. 1. As shown in FIG. 2A, the first waveguide 101, the first ring 103A, the second ring 107A, and the second waveguide 109 have rectangular cross-sections and may all be within an optical device layer 201 over a substrate 203. Providing the first ring 103A and the second ring 107A with rectangular cross-sections may make their group indexes more predictable.

FIG. 2B illustrates a cross-sectional view 200B corresponding to another embodiment of the PIC device 100 of FIG. 1. In this embodiments, the first waveguide 101, the first ring 103A, the second ring 107A, and the second waveguide 109 have sidewalls 205 that are tapered by an angle θ. The taper angle θ may result from a lower energy etch process or other etch conditions that result in less vertical and more isotropic etching in comparison to the processes used to provide the vertical sidewalls shown in the cross-sectional view 200A of FIG. 2A. The lower energy process may be a more reproducible process. In some embodiments, the angle θ is about 3° or more. In some embodiments, the angle θ is about 10° or more.

FIG. 2C illustrates a cross-sectional view 200C corresponding to another embodiment of the PIC device 100 of FIG. 1. In this embodiments, the first waveguide 101, the first ring 103A, the second ring 107A, and the second waveguide 109 have sidewalls 205 have curved lower surfaces 207. The curved lower surfaces 207 may be another artifact of a lower energy etch process or other etch conditions that result in more isotropic etching in comparison to the processes used to provide the rectangular cross-sections shown in the cross-sectional view 200A of FIG. 2A. The condition that produce the curved lower surfaces 207 may be more reproducible than conditions that lead to rectangular cross-sections, and may therefore lend themselves to fine tuning of the effective lengths of the first ring 103A and the second ring 107A.

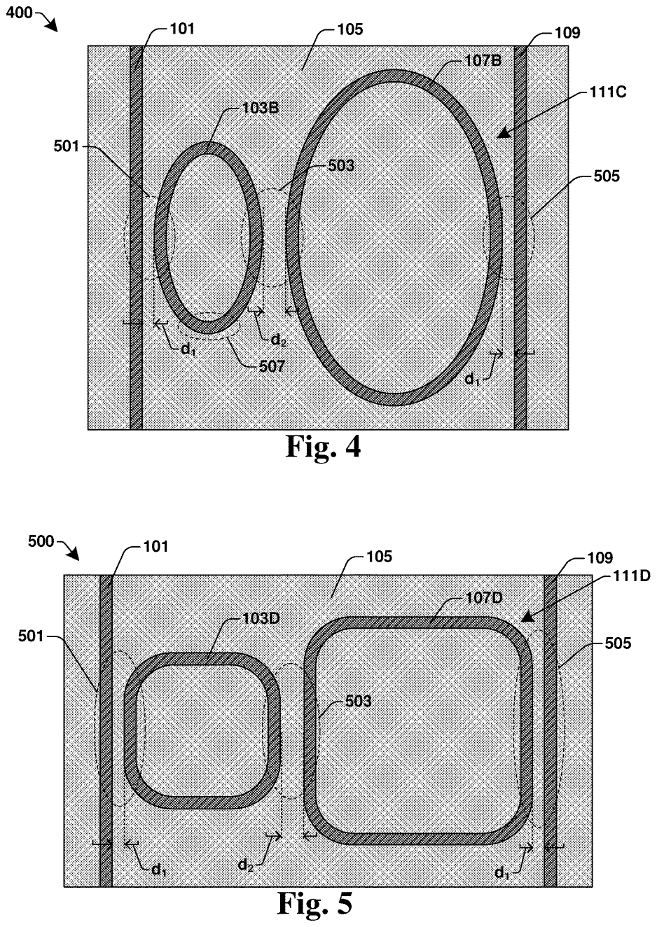

FIG. 3 illustrates a plan view of a PIC device 300 comprising an asymmetric dual ring resonator 111B. The asymmetric dual ring resonator 111B comprises a first ring 103B optically coupled with a second ring 107B. The asymmetric dual ring resonator 111B is like the asymmetric dual ring resonator 111A of FIG. 1 except that the first ring 103B and the second ring 107B are non-circular. For example, the first ring 103B and the second ring 107B may be elliptical.

FIG. 4 illustrates a plan view of a PIC device 400 comprising an asymmetric dual ring resonator 111C. The asymmetric dual ring resonator 111C is like the asymmetric dual ring resonator 111B of FIG. 3 except that the first ring 103B and the second ring 107B are oriented so that their major axes are parallel to the first waveguide 101 and the second waveguide 109. This configuration allows the first waveguide 101 and the second waveguide 109 to be place more closely together.

The first ring 103B has an increased radius of curvature in a zone 501 where the first ring 103B couples with the first waveguide 101. The radius of curvature is increased relative to some other locations along the perimeter of the first ring 103B such as the zone 507 and is also increased compared to a circular ring having the same effective length. This increased radius of curvature may be used to increase the coupling coefficient between the first ring 103B and the first waveguide 101. Even if the distance d₁ is increased so that the coupling coefficient is the same as for the first ring 103A of FIG. 1, the increased radius of curvature in the zone 501 reduces a sensitivity of the coupling coefficient to manufacturing process variations. The second ring 107B may likewise have an increased radius of curvature in a zone 505 where the second ring 107B couples with the second waveguide 109.

The first ring 103B and the second ring 107B may also have increased radii of curvatures in a zone 503 where they couple with one another. As discussed previously, it is desirable to maintain the degree of coupling between the first ring 103B and the second ring 107B within a limited range. Increasing the radii of curvatures within the zone 503 provides a given degree of coupling with a larger distance d₂ between the first ring 103B and the second ring 107B and makes the coupling coefficient less sensitive to manufacturing process variations.

FIG. 5 illustrates a plan view of a PIC device 500 comprising an asymmetric dual ring resonator 111D comprising a first ring 103D and a second ring 107D. The asymmetric dual ring resonator 111D is like the asymmetric dual ring resonator 111C of FIG. 4 except that the first ring 103D and the second ring 107D become linear (have infinite radii of curvature) and are parallel with their coupling partners in the zones 501 and 505 where they couple with the first waveguide 101 and the second waveguide 109 respectively, and in the zone 503 where they couple with one another. The advantages of these structures are similar to those described for the asymmetric dual ring resonator 111C of FIG. 4.

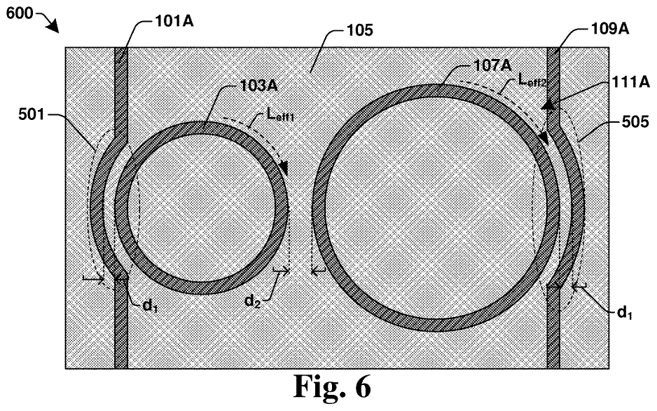

FIG. 6 illustrates a plan view of a PIC device 600 comprising the asymmetric dual ring resonator 111A coupled between a first waveguide 101A and a second waveguide 109A. The first waveguide 101A has parallel curvature with the first ring 103A in the zone 501 where the first waveguide 101A couples with the first ring 103A. Likewise, the second waveguide 109A has parallel curvature with the second ring 107A in the zone 505 where the second waveguide 109A couples with the second ring 107A. The distance d₁ may be maintained throughout these regions of parallel curvature. This structure provides an alternative approach to providing high coupling coefficients between the first ring 103A and the first waveguide 101A and between and the second ring 107A and the second waveguide 109A.

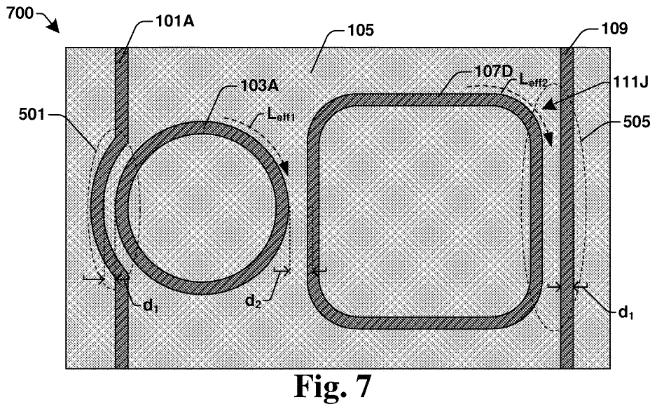

FIG. 7 illustrates a plan view of a PIC device 700 comprising an asymmetric dual ring resonator 111J. The asymmetric dual ring resonator 111J comprises the first ring 103A, which is circular, and the second ring 107D, which is non-circular. The first ring 103A is coupled to the first waveguide 101A in the zone 501. In the zone 501, the first waveguide 101A has a curvature matching that of the first ring 103A. The second ring 107D is coupled to the second waveguide 109 in the zone 505. In the zone 505, the second ring 107D becomes linear and parallel to the second waveguide 109. Because the second ring 107D has a greater effective length than the first ring 103A, it is easier to make the shape of the second ring 107D deviate from circularity without affecting resonance.

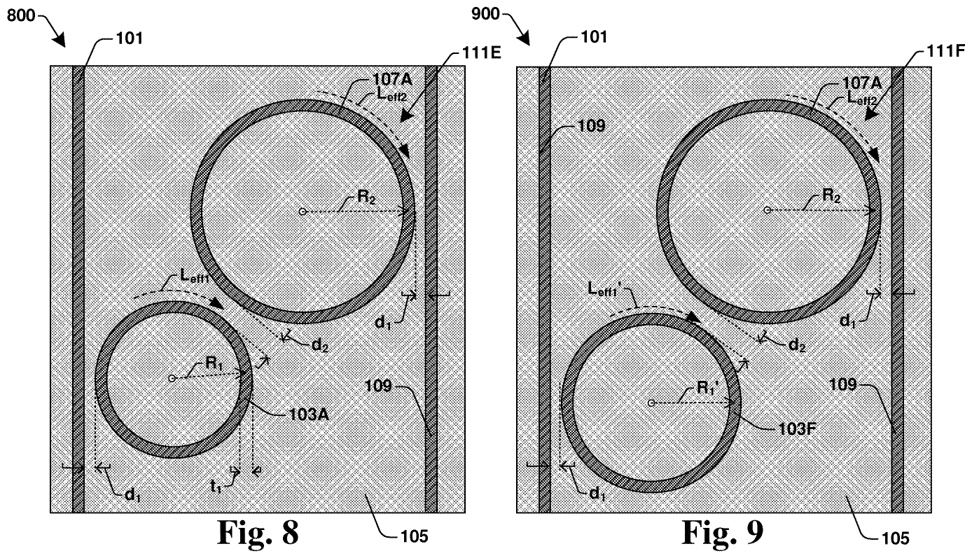

FIG. 8 illustrates a plan view of a PIC device 800 comprising an asymmetric dual ring resonator 111E coupled between the first waveguide 101 and the second waveguide 109. The asymmetric dual ring resonator 111E differs from the asymmetric dual ring resonator 111A of FIG. 1 in that the first ring 103A is offset with respect to a shortest path between the first waveguide 101 and the second ring 107A.

FIG. 9 illustrates a plan view of a PIC device 900 comprising an asymmetric dual ring resonator 111F coupled between the first waveguide 101 and the second waveguide 109. The asymmetric dual ring resonator 111F differs from the asymmetric dual ring resonator 111E of FIG. 8 in that the asymmetric dual ring resonator 111F comprises a first ring 103F that has a modified first radius R₁′ and a modified first effective length L_{eff1}′ which is greater that the first effective length L_{eff1} of the first ring 103A (see FIG. 8). A comparison of FIG. 8 and FIG. 9 shows an advantage of the offset arrangement: the first effective length L_{eff1} of the first ring 103A may be adjusted while maintaining the distances d₁ and d₂ and without altering the positions of either the first waveguide 101, the second waveguide 109, or the second ring 107A. This may be useful in fine tuning the relationship between the first effective length L_{eff1} and the second effective length L_{eff2} so that the FSR of the asymmetric dual ring resonator 111F is larger than that of a single ring resonator having either the first effective length L_{eff1} or the second effective length L_{eff2}. Fine tuning of the first effective length L_{eff1} may also be used to improve the Q-factor.

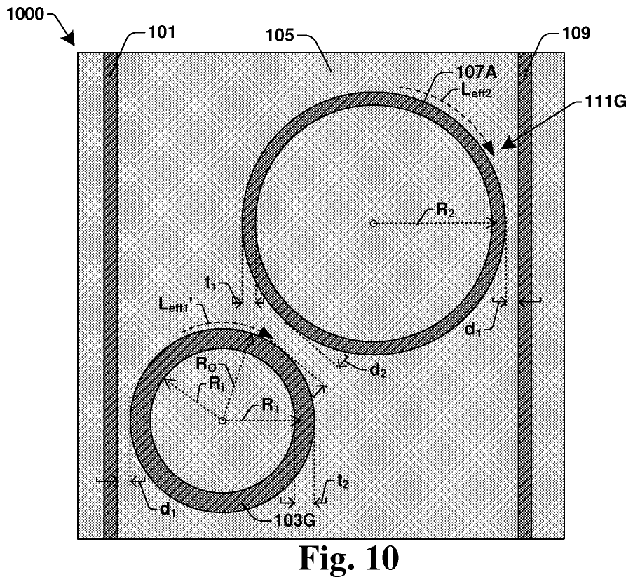

FIG. 10 illustrates a plan view of a PIC device 1000 comprising an asymmetric dual ring resonator 111G. The asymmetric dual ring resonator 111G differs from the asymmetric dual ring resonator 111E of FIG. 8 in that the asymmetric dual ring resonator 111G comprises a first ring 103G that has a larger radial thickness t₂ than the radial thickness t₁ of the first ring 103A (see FIG. 8) or the radial thickness of the second ring 107A. Adjusting the radial thickness t₂ changes the first effective length L_{eff1} to the modified first effective length L_{eff1}′ by altering the group index and provides another approach to fine tuning the first effective length L_{eff1} while maintaining the distances d₁ and d₂ and without altering the positions of either the first waveguide 101, the second waveguide 109, or the second ring 107A.

In some embodiments, both the radial thickness t₁ and the radial thickness t₂ are within the range from about 300 nm to about 500 nm so that transmissions are confined to one optical mode and optical losses are avoided. Variations within that range may be sufficient for fine tuning. For example, adjusting the radial thickness of a 5 μm radius ring of silicon (Si) from 370 nm to 470 nm changes the group index from about 4.16 to about 4.10, which provide a 1.4% change in effective length. As shown by FIG. 4, even a 0.05% variation in effective length can have a significant effect.

In some embodiments, the radial thickness is adjusted by varying the inner radius R₁ while keeping the outer radius R₀ constant. The radius of a ring resonator is half the sum of the inner radius R₁ and the outer radius R₀. If the radial thickness t₁ is increased by reducing the inner radius R₁ while keeping the outer radius R₀ constant, the modified first effective length L_{eff1}′ may be adjusted without altering the position or the footprint of the first ring 103G.

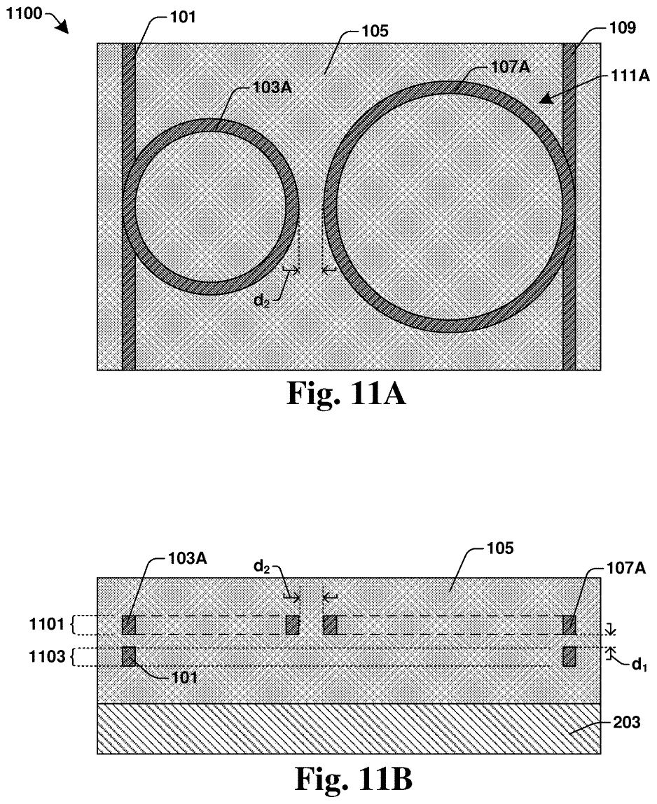

FIG. 11A illustrates a plan view and FIG. 11B illustrates a cross-sectional view of a PIC device 1100 the includes the asymmetric dual ring resonator 111A. The PIC device 1100 differs from the PIC device 100 of FIG. 1 in that the asymmetric dual ring resonator 111A is in a first device layer 1101 whereas the first waveguide 101 and the second waveguide 109 that provide the input and output waveguides for the asymmetric dual ring resonator 111A are in a second device layer 1103. This configuration has the advantage that the distance d₁ and the associated coupling coefficients may be precisely controlled according to the thickness of the cladding 105 between the first device layer 1101 and the second device layer 1103.

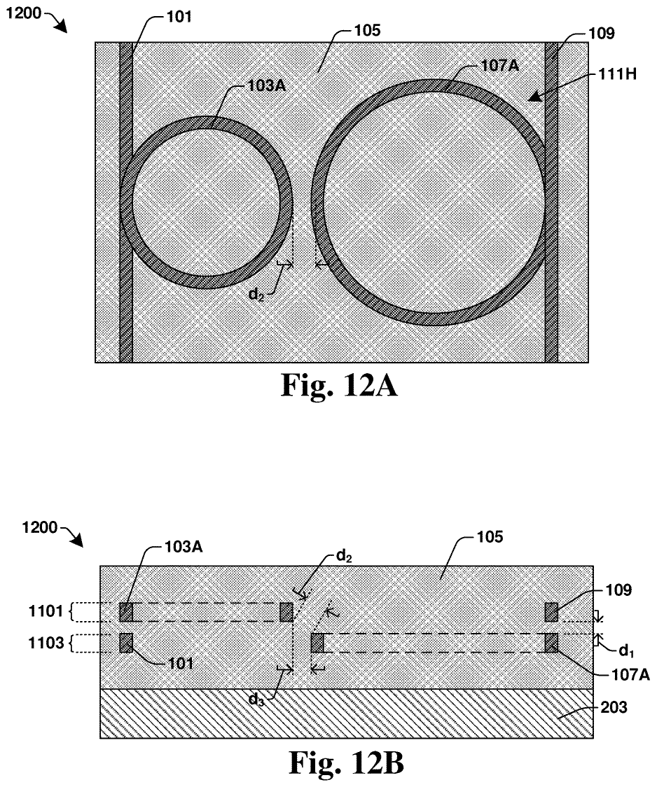

FIG. 12A illustrates a plan view and FIG. 12B illustrates a cross-sectional view of a PIC device 1200 that includes an asymmetric dual ring resonator 111H. The asymmetric dual ring resonator 111H differs from the asymmetric dual ring resonator 111A in the PIC device 1100 of FIGS. 11A and 11B in that the asymmetric dual ring resonator 111H has the first ring 103A and the second ring 107A in different device layers. The distance d₁ may be determined by the thickness of the cladding 105 between the first device layer 1101 and the second device layer 1103. The distance d₂ between the first ring 103A and the second ring 107A may be independently adjusted by varying a lateral offset d₃ between the first ring 103A and the second ring 107A. The distance d₂ varies more slowly with respect to the lateral offset d₃ when the first ring 103A and the second ring 107A are in different device layer as compared to the case where the first ring 103A and the second ring 107A, which makes the distance d₂ less sensitive to manufacturing process variations.

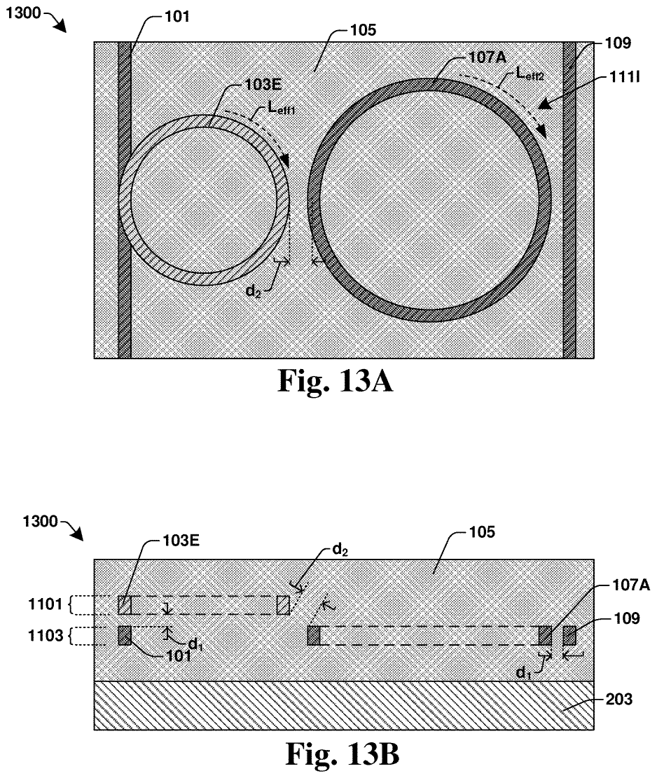

FIG. 13A illustrates a plan view and FIG. 13B illustrates a cross-sectional view of a PIC device 1300 that includes an asymmetric dual ring resonator 111I. The asymmetric dual ring resonator 111I differs from the asymmetric dual ring resonator 111H of FIGS. 12A and 12B in that the asymmetric dual ring resonator 111I has a first ring 103E. The first ring 103E is in a separate device layer from the first waveguide 101, the second waveguide 109, and the second ring 107A. This structure allows the first ring 103E to have a distinct composition from the first waveguide 101, the second waveguide 109, and the second ring 107A. Providing the first ring 103E with a distinct composition provides another way in which L_{eff1} may be made to vary with respect to L_{eff2}. If the optical devices in the first device layer 1101 are composed of an optical material having a lower refractive index than the optical devices in the second device layer 1103, than the first effective length L_{eff1} may be made smaller without physically reducing the size of the first ring 103E. This structure may also be used to provide the first ring 103E as a non-linear optical material.

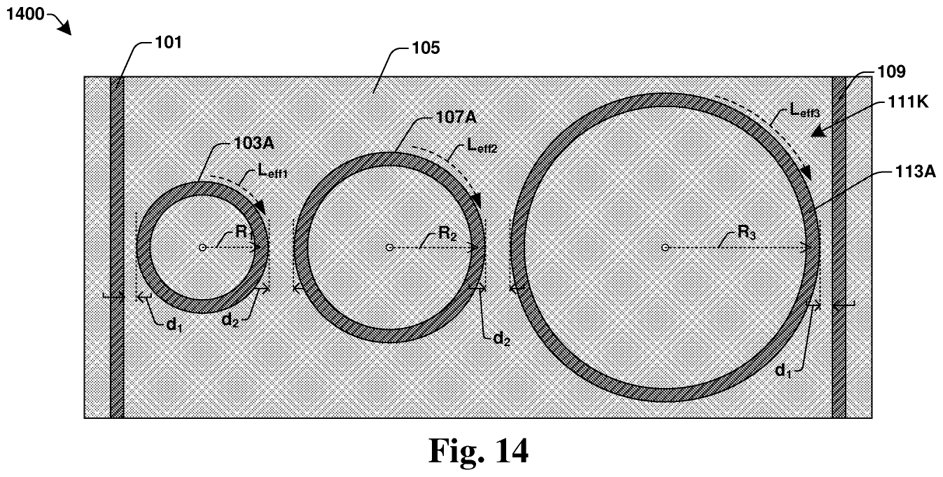

FIG. 14 illustrates a plan view of a PIC device 1400 comprising an asymmetric multi-ring resonator 111K. The asymmetric multi-ring resonator 111K comprises the first ring 103A having the first radius R₁ and the effective length L_{eff1}, the second ring 107A having the second radius R₂ and the second effective length Left₂, and a third ring 113A having a third radius R₃ and a third effective length L_{eff3}. The first radius R₁, the second radius R₂, and the third radius R₃ are each distinct so that the first effective length L_{eff1}, the second effective length L_{eff2}, and the third effective length L_{eff3} are distinct.

In some embodiments, the first effective length L_{eff1}, the second effective length L_{eff2}, and the third effective length L_{eff3}, have a greatest common divisor that is smaller than any of the first effective length L_{eff1}, the second effective length L_{eff2}, and the third effective length L_{eff3}, and is smaller than the greatest common divisor any pair of the first effective length L_{eff1}, the second effective length L_{eff2}, and the third effective length L_{eff3}. For example, L_{eff1}, L_{eff2}, and L_{eff3} may have nearly the proportions 6:10:15 so that their greatest common divisor is one sixth L_{eff1}. In this example, the FSR is six times greater than the FSR that would be realized using just the smallest of the three rings. The same FSR might be realized using a dual ring resonator having nearly the proportions 6:7. Replacing the size 7 ring with two larger rings (sizes 10 and 15) may reduce the sensitivity to manufacturing tolerances and improve the differentiation between resonant peaks and side modes.

In some embodiments, the first effective length L_{eff1}, the second effective length L_{eff2}, and the third effective length L_{eff3}, have a greatest common divisor that is smaller than any of the first effective length L_{eff1}, the second effective length L_{eff2}, and the third effective length L_{eff3}, but is not smaller than the greatest common divisor of two of the three rings. For example, L_{eff1}, L_{eff2}, and L_{eff3} may have nearly the proportions 2:3:5 so that their greatest common divisor is one half L_{eff1}. In this embodiment, the third ring may provide additional wavelength filtering and may improve the differentiation between resonant peaks and side modes.

FIG. 15 illustrates a plan view of a PIC device 1500 comprising an asymmetric multi-ring resonator 111L. The asymmetric multi-ring resonator 111L comprises two of the first ring 103A and one of the second ring 107A. Using two rings having a first effective length and another ring having a second effective length combines the benefits of a heterogeneous dual ring resonator (smaller FSR) with those of a symmetric dual ring resonator (e.g., improved filtering).

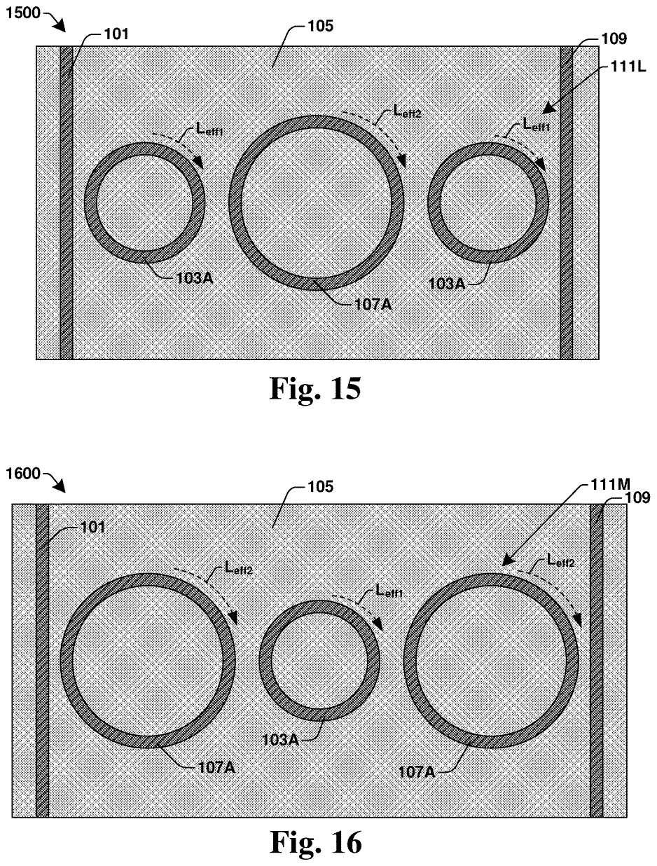

FIG. 16 illustrates a plan view of a PIC device 1600 comprising an asymmetric multi-ring resonator 111M. The asymmetric multi-ring resonator 111L comprises one of the first ring 103A with two of the second ring 107A. Making the two rings having the same size smaller as in the asymmetric multi-ring resonator 111L of FIG. 15 provides a more compact design. Making the two rings having the same size larger as in the asymmetric multi-ring resonator 111M of FIG. 16 may reduce sensitivity to manufacturing tolerances.

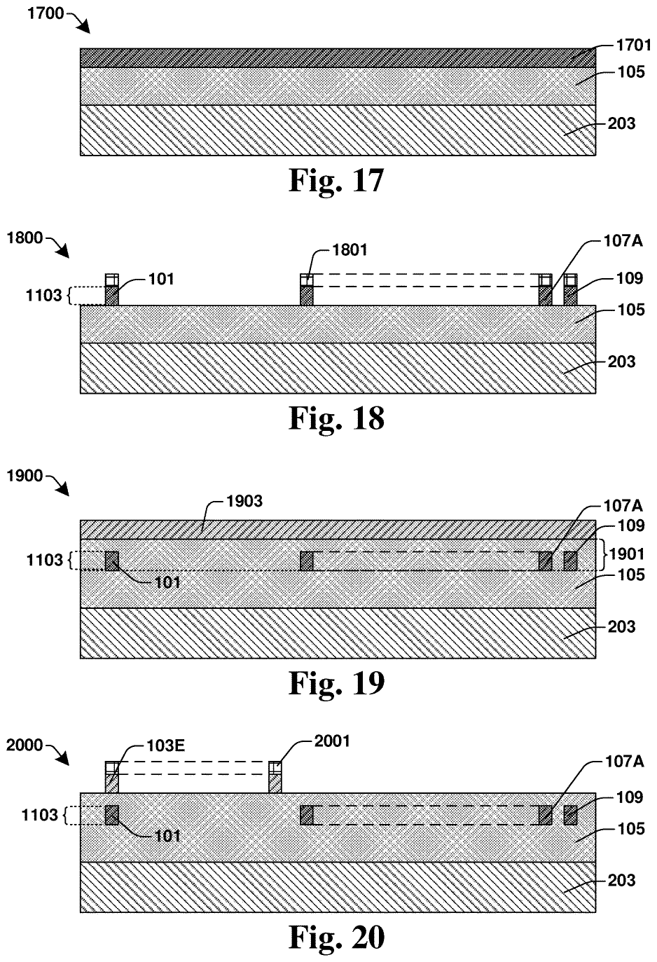

FIGS. 17-20 are cross-sectional view illustrations exemplifying a process according to the present disclosure. While FIGS. 17-20 are described with reference to various embodiments of a method, it will be appreciated that the structures shown in FIGS. 17-20 are not limited to the method but rather may stand alone separate from the method. FIGS. 17-20 are described as a series of acts. The order of these acts may be altered in other embodiments. While FIGS. 17-20 illustrate and describe a specific set of acts, some may be omitted in other embodiments. Further, acts that are not illustrated and/or described may be included in other embodiments.

As shown by the cross-sectional view 1700 of FIG. 17, the method may begin by providing a substrate 203 with a layer of cladding 105 and a first optical material layer 1701. The substrate 203 with the layer of cladding 105 and the first optical material layer 1701 may be provided by a semiconductor on insulator substrate (SOI), or the layer of cladding 105 and the first optical material layer 1701 may be deposited on the substrate 203. The substrate 203 may be, for example, an SOI substrate, a bulk semiconductor substrate, a silicon on a sapphire substrate, the like, or any other suitable type of substrate. The semiconductor may be silicon (Si), a group III-V semiconductor or some other binary semiconductor (e.g., GaAs), a tertiary semiconductor (e.g., AlGaAs), a higher order semiconductor, or the like. The cladding 105 may be silicon dioxide (SiO₂), the like, or some other cladding material. The first optical material layer 1701 may be silicon (Si), silicon nitride (SiN), the like, or some other optical material. In some embodiments, the first optical material layer 1701 has a thickness in the range from about 100 nm to about 1000 nm. In some embodiments, the first optical material layer 1701 has a thickness in the range from about 300 nm to about 500 nm.

As shown by the cross-sectional view 1800 of FIG. 18, a mask 1801 may be formed and used to pattern the second device layer 1103 from the first optical material layer 1701. Patterning may form the first waveguide 101, the second ring 107A, and the second waveguide 109. Alternatively, the second device layer 1103 may be formed by a damascene process.

As shown by the cross-sectional view 1900 of FIG. 19, an additional layer 1901 of cladding 105 and a second optical material layer 1903 may be deposited over the structure shown by the cross-sectional view 1800 of FIG. 18. Optionally, a first portion of the additional layer 1901 is deposited and planarized to the second device layer 1103 before depositing a second portion of the additional layer 1901. That planarization process will facilitate precise control of the thickness of the cladding 105 between the second device layer 1103 and the second optical material layer 1903. The additional layer 1901 of cladding 105 and the second optical material layer 1903 may be deposited by chemical vapor deposition (CVD), physical vapor deposition (PVD), atomic layer deposition (ALD), the like, or any other suitable process(es). The second optical material layer 1903 may have the same composition as the same as the first optical material layer 1701 or may have a distinct composition.

In some embodiments, at least one of the first optical material layer 1701 and the second optical material layer 1903 is a conventional optical material layer. In some embodiments, at least one of the first optical material layer 1701 and the second optical material layer 1903 is a non-linear optical material layer. As the terms is used herein, a nonlinear optical material is one that has a non-centrosymmetric crystalline structure. In contrast to a conventional optical material, a nonlinear optical material has a non-zero second-order nonlinear susceptibility and exhibits the Pockels effect. The Pockels effect causes a variation in refractive index that is linear in relation to the strength of an applied electric field. In some embodiments, the nonlinear optical material has a second-order nonlinear susceptibility of at least about 10⁻²⁴ As/V². The nonlinear optical material may provide or enhance nonlinear optical effects within the PIC. Examples of nonlinear optical effects that may be provided or enhanced include parametric down-conversion (frequency doubling), sum-frequency generation, optical parametric generation, optical parametric amplification, optical parametric oscillation, optical rectification, and the like. Examples of nonlinear optical material that have these characteristic include aluminum nitride (AlN), lithium niobate (LiNbO₃), silicon carbide (SiC), indium phosphide (InP), gallium arsenide (GaAs), aluminum gallium arsenide (AlGaAs), and the like. In some embodiments, the nonlinear optical material is aluminum nitride (AlN) or the like. AlN is particularly is well suited for CMOS compatible processing and may be used to provide a variety of nonlinear optical effects.

As shown by the cross-sectional view 2000 of FIG. 20, a mask 2001 may be formed and used to pattern the first device layer 1101 from the second optical material layer 1903. Patterning may form the first ring 103E. Alternatively, the first device layer 1101 may be formed by a damascene process. Additional cladding may be deposited to form the PIC device 1100 of FIGS. 11A and 11B or some other PIC device.

PIC devices according to the present disclosure may contain optical devices in addition to the ones that are illustrated. An optical device may be any device that transmits, receives, propagates, generates, modifies, or detects optical signals, any device that transform optical signals to electrical signals, or any device that transforms electrical signals to optical signal. Examples of optical devices that transmit, receive, propagate, generate, modify, or detect optical signals include waveguides, splitters, multiplexers, filters, modulators (e.g., a phase shifter, a PiN modulator, or an electro-absorption modulator), sensors, switches (e.g., a Mach-Zehnder interferometer), amplifiers, edge couplers, grating couplers, ring resonators, and the like. Examples of optical devices that transforms electrical signals to optical signals include laser diodes, light-emitting diodes, and the like. Examples of optical devices that transform optical signals to electrical signals include photodetectors and the like.

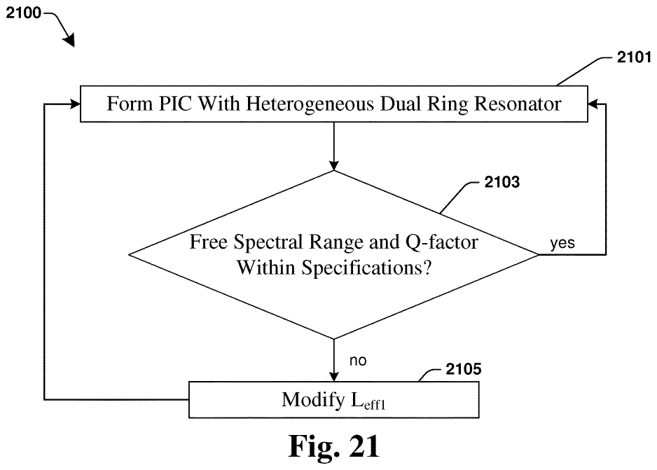

FIG. 21 presents a flow chart for a process 2100 that may be used to form a PIC device according to the present disclosure. While the process 2100 of FIG. 21 is illustrated and described herein as a series of acts or events, it will be appreciated that the illustrated ordering of such acts or events is not to be interpreted in a limiting sense. For example, some acts may occur in different orders and/or concurrently with other acts or events apart from those illustrated and/or described herein. Further, not all illustrated acts are required to implement one or more aspects or embodiments of the description herein, and one or more of the acts depicted herein may be carried out in one or more separate acts and/or phases.

The process 2100 may begin with act 2101, forming a PIC device that include an asymmetric dual ring resonator. The cross-sectional views 1300-2000 of FIGS. 13-20 provide an example. The asymmetric dual ring resonator may be in a single device layer or may have rings in two distinct device layers.

Act 2103 is determining whether the asymmetric dual ring resonator has an FSR and Q-factor within design specifications. This may involve measuring transmission intensity drop as a function of wavelength. The determination may include such factors as whether the resonance modes have single peaks or dual peaks and whether the side modes are sufficiently differentiated from the desired resonance modes. If the FSR and Q-factor are within design specifications, the process 2100 proceeds to make additional devices having the same asymmetric dual ring resonator layout. If the FSR or the Q-factor is not within design specifications, the process 2100 proceeds with act 2105, making a modification to the device layout that changes L_{eff1} (or L_{eff2}). In some embodiments, the modification comprises adjusting R₁ or otherwise enlarging or shrinking the one of the rings. The PIC devices 800 and 900 of FIGS. 8 and 9 provide an example of this type of adjustment. In some embodiments, the modification comprises adjusting the radial thickness of one of the rings. The PIC devices 800 and 1000 of FIGS. 8 and 10 provide an example of this type of adjustment.

Some aspects of the present disclosure relate to a photonic integrated circuit device that includes a first waveguide, a second waveguide, and a multi-ring resonator over a substrate. The multi-ring resonator has a first ring having a first effective length and a second ring having a second effective length. The effective lengths are such that the multi-ring resonator has a larger free spectral range than a single ring resonator having the first effective length or a single ring resonator having the second effective length. The multi-ring resonator is coupled between the first waveguide and the second waveguide. In some embodiments, the larger free spectral range is within an order of magnitude of a free spectral range of a single ring resonator having either the first effective length or the second effective length. In some embodiments, the multi-ring resonator has primary resonant modes separated by a free spectral range and side resonant modes within the free spectral range, and the side resonant modes have at least an order of magnitude lower intensity that the primary resonant modes. In some embodiments, the first effective length and the second effective length are sufficiently near integer multiples of a third effective length that the primary resonant modes have a single peak.

In some embodiments, the first ring has a radial thickness distinct from the second ring. In some embodiments, the multi-ring resonator supports only one optical mode. In some embodiments, a first spacing between the first ring and the second ring is greater than a second spacing between the first ring and the first waveguide and is greater than a third spacing between the second ring and the second waveguide. In some embodiments, the first ring has a non-circular perimeter. In some embodiments, the first ring has a coupling region in which the first ring has a first radius of curvature, the first ring has a non-coupling region which is distinct from the coupling region and in which the first ring has a second radius of curvature, and the first radius of curvature is greater than the second radius of curvature. In some embodiments, the first waveguide and the second waveguide have a first elevation over the substrate, the first ring has a second elevation over the substrate, and the first elevation is distinct from the second elevation. In some embodiments, the second ring has the second elevation over the substrate. In some embodiments, the second ring has the first elevation over the substrate. In some embodiments, the first waveguide has a coupling region with the first ring, and the first waveguide is curved in the coupling region. In some embodiments, the first ring is offset with respect to alignment between the first waveguide and the second ring.

Some aspects of the present disclosure relate to a photonic integrated circuit device that includes a first waveguide, a second waveguide, a first ring, and a second ring over a substrate. The first ring has a first effective length and is optically coupled to the first waveguide. The second ring has a second effective length and is optically coupled to the second waveguide and to the first ring. The first effective length is a first integer multiple of a third effective length. The second effective length is a second integer multiple of the third effective length. The first integer is distinct from the second integer. In some embodiments, the first integer multiple and the second integer multiple are in a range from 2 to 12. In some embodiments, they are both 10 or less. In some embodiments, they are both 7 or less. In some embodiments, they are both 4 or less. In some embodiments, they are 2 and 3.

In some embodiments, the first ring has a radial thickness distinct from a thickness of the first waveguide. In some embodiments, the first ring supports only one optical mode. In some embodiments, a first coupling coefficient between the first ring and the first waveguide is greater than a second coupling coefficient between the first ring and the second ring. In some embodiments, the first waveguide has a parallel curvature to the first ring in a zone where the first waveguide is coupled to the first.

Some aspects of the present disclosure relate to a method that includes providing a substrate and forming a multi-ring resonator, a first waveguide, and a second waveguide, over the substrate. The multi-ring resonator includes a first ring and a second ring. The first ring has a first effective length, and the second ring has a second effective length. The first effective length and the second effective lengths are such that the multi-ring resonator has a larger free spectral range than a single ring resonator having wither the first effective length or the second effective length. The first ring may be coupled to the first waveguide, and the second ring may be coupled to the second waveguide. In some embodiments, the method further includes forming a first optical device layer and forming a second optical device layer. Forming the first optical device layer creates the first ring and forming the second optical device layer creates the second ring. The first and second rings may have distinct compositions.

In some embodiments, the first ring and the second ring are formed according to a layout and the method include revising the layout to adjust either the first effective length or the second effective length. In some embodiments, the adjustment includes altering a thickness of the first ring or the second ring. In some embodiments, the adjustment includes increasing or decreasing a perimeter length of either the first ring or the second ring.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic integrated circuit device, comprising:
a substrate;
a first waveguide over the substrate;
a second waveguide over the substrate; and
a multi-ring resonator comprising a first ring having a first effective length and a second ring having a second effective length, wherein the multi-ring resonator is coupled between the first waveguide and the second waveguide and has a larger free spectral range than a single ring resonator having the first effective length or a single ring resonator having the second effective length.

2. The photonic integrated circuit device of claim 1, wherein the larger free spectral range is within an order of magnitude of a free spectral range of a single ring resonator having either the first effective length or the second effective length.

3. The photonic integrated circuit device of claim 1, wherein the multi-ring resonator has primary resonant modes separated by a free spectral range and side resonant modes within the free spectral range, and the side resonant modes have at least an order of magnitude lower intensity that the primary resonant modes.

4. The photonic integrated circuit device of claim 3, wherein the first effective length and the second effective length are sufficiently near integer multiples of a third effective length that the primary resonant modes have a single peak.

5. The photonic integrated circuit device of claim 1, wherein the first ring has a radial thickness distinct from the second ring.

6. The photonic integrated circuit device of claim 5, wherein the multi-ring resonator supports only one optical mode.

7. The photonic integrated circuit device of claim 1, wherein a first spacing between the first ring and the second ring is greater than a second spacing between the first ring and the first waveguide and is greater than a third spacing between the second ring and the second waveguide.

8. The photonic integrated circuit device of claim 1, wherein the first ring has a non-circular perimeter.

9. The photonic integrated circuit device of claim 8, wherein:
the first ring has a coupling region in which the first ring has a first radius of curvature;
the first ring has a non-coupling region which is distinct from the coupling region and in which the first ring has a second radius of curvature; and
the first radius of curvature is greater than the second radius of curvature.

10. The photonic integrated circuit device of claim 1, wherein the first waveguide and the second waveguide have a first elevation over the substrate, the first ring has a second elevation over the substrate, and the first elevation is distinct from the second elevation.

11. The photonic integrated circuit device of claim 1, wherein the first ring has a first elevation over the substrate, the second ring has a second elevation over the substrate, the first elevation is distinct from the second elevation, and the first ring has a distinct composition from the second ring.

12. The photonic integrated circuit device of claim 1, wherein the first waveguide has a coupling region with the first ring, and the first waveguide is curved in the coupling region.

13. The photonic integrated circuit device of claim 1, wherein the multi-ring resonator further comprises a third ring having the first effective length.

14. The photonic integrated circuit device of claim 1, wherein the multi-ring resonator further comprises a third ring having a third effective length, wherein the third effective length is distinct from the first effective length and from the second effective length.

15. A photonic integrated circuit device, comprising:
a substrate;
a first waveguide over the substrate;
a first ring, wherein the first ring has a first effective length; and
a second ring, wherein the second ring has a second effective length and is optically coupled between the first waveguide and the first ring;
wherein the first effective length is a first integer multiple of a third effective length;
the second effective length is a second integer multiple of the third effective length;
the first integer multiple is distinct from the second integer multiple; and
the first integer multiple and the second integer multiple are integers greater than one.

16. The photonic integrated circuit device of claim 15, wherein the first integer multiple and the second integer multiple are in a range from 2 to 12.

17. The photonic integrated circuit device of claim 15, wherein a first coupling coefficient between the first ring and the first waveguide is greater than a second coupling coefficient between the first ring and the second ring.

18. The photonic integrated circuit device of claim 15, wherein the first waveguide has a parallel curvature to the first ring in a zone where the first waveguide is coupled to the first ring.

19. A method, comprising:
providing a substrate; and
forming a multi-ring resonator, a first waveguide, and a second waveguide, over the substrate, wherein multi-ring resonator comprises a first ring and a second ring, the first ring has a first effective length, the second ring has a second effective length, the multi-ring resonator has a larger free spectral range than a single ring resonator having the first effective length or a single ring resonator having the second effective length, the first ring is coupled to the first waveguide, and the second ring is coupled to the second waveguide.

20. The method of claim 19, further comprising:
forming a first optical device layer, wherein forming the first optical device layer creates the first ring; and
forming a second optical device layer, wherein forming the second optical device layer creates the second ring.
